(19) United States
(12) Patent Application Publication
(10) Pub. No.: US 2014/0358604 A1
(43) Pub. Date: Dec. 4, 2014

(54) THREE-DIMENSIONAL REPRESENTATION OF SOFTWARE USAGE

(71) Applicants: ALEXANDER GEBHART, Ubstadt-Weiher (DE); Clemens Daeschle, Neckarsteinach (DE)

(72) Inventors: ALEXANDER GEBHART, Ubstadt-Weiher (DE); Clemens Daeschle, Neckarsteinach (DE)

(73) Assignee: SAP AG, Walldorf (DE)

(21) Appl. No.: 13/907,142

(22) Filed: May 31, 2013

(51) Int. Cl. G06Q 10/06

(52) U.S. Cl. CPC G06Q 10/06
USPC 705/7.12

(57) ABSTRACT

In some example implementations, there is provided a method. The method may include receiving metadata representative of usage of a component of a system; generating, based on the received metadata and a model, a three-dimensional representation of the usage of the system including at least one of the component and a structure of the component, the model based on a geographic entity; and providing the generated three-dimensional representation as a page for presentation. Related systems, methods, and articles of manufacture are also provided.

### TECHNICAL FIELD

This disclosure relates generally to data visualization.

### BACKGROUND

There is, and will continue to be, advances and changes in how enterprises conduct business. Whether these advances and changes occur through growing competition and globalization, mergers and acquisitions, or a revamping of business models, the key for success will often depend on how quickly the enterprise's information technology (IT) organization can adapt to evolving business needs. Therefore, a major challenge to these enterprises is how they handle change. For organizations to enable business agility, they must ensure that enterprise applications are not only high-performance business engines driving efficiencies, but also that they become flexible building blocks capable of handling changes based on the needs of the end-user.

### SUMMARY

In some example implementations, there is provided a method. The method may include receiving metadata representative of usage of a component of a system; generating, based on the received metadata and a model, a three-dimensional representation of the usage of the system including at least one of the component and a structure of the component, the model based on a geographic entity; and providing the generated three-dimensional representation as a page for presentation.

In some variations, one or more of the features disclosed herein including the following features can optionally be included in any feasible combination. The geographic entity may represent a city. The structure may represent one or more layers of a software-based system including the component. The metadata may include information representative of the system including the component, a configuration of the system including the component, a frequency of access to the component, and a code size for the component. The metadata further include other metadata for other components of the system, dependency information representative of a relationship among the component and the other components, and usage information for the component and the other components. The component may be represented as a first building in the city generated on the page, and the other components are represented as other buildings in the city generated on the page. A first selection of the component representing the first building may be received. In response to the selection, a parametric information for the component may be provided, wherein the parametric is provided to the page for presentation at a user interface. The system may be monitored to obtain the metadata. The page may be presented at a user interface. The model may define the three-dimensional representation of the city including the component configured as a first building in the city generated on the page, other components represented as other buildings in the city generated on the page, a size for at least one of the first building and the other building based on at least the usage and a code size for the component or the other components.

Articles are also described that comprise a tangibly embodied machine-readable medium embodying instructions that, when performed, cause one or more machines (e.g., computers, etc.) to result in operations described herein. Similarly, computer systems are also described that can include a processor and a memory coupled to the processor. The memory can include one or more programs that cause the processor to perform one or more of the operations described herein.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an example of a three-dimensional visualization of software usage, according to some implementations of the current subject matter;

FIG. 2 illustrates an example of a system for generating three-dimensional visualization of software usage, according to some implementations of the current subject matter; and

FIG. 3 illustrates an example of a process for generating three-dimensional visualization of software usage, according to some implementations of the current subject matter.

### DETAILED DESCRIPTION

A system including software-based components may be complex having dozens if not hundreds of functional components. This complexity may lead to difficulties in determining which functional components are actually in use at any given system, and the dependencies between those functional components further complicate determining whether components are actually being used. For example, a system may include functional components that are not used by an end-user at a certain installation, so that functional component can be deleted, inhibited, replaced, or, perhaps, modified to encourage use by the end-user. However, identifying these components that are not, or rarely, used may present an extremely burdensome, if not impossible, task given the noted complexity. Moreover, changes, if done incorrectly, to a functional component can adversely impact system operation. As such, a software developer can be faced with not being able to make a correct decision regarding functional component usage. To that end, the subject matter disclosed herein relates to providing a three-dimensional representation of a system, such as a software-based business system, including the dependencies among the functional components of the system. Further, the visualization may provide an indication of the actual usage by end-users of the system components.

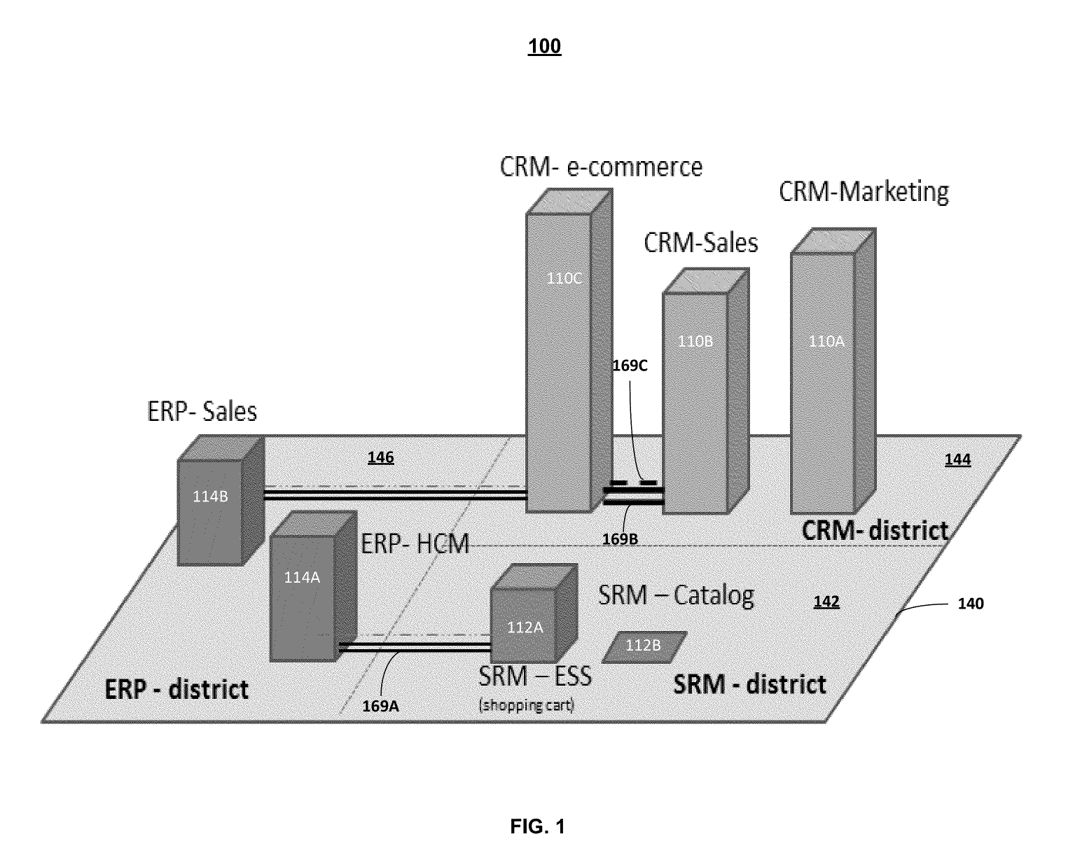

FIG. 1 depicts an example of a 3D visualization 100. The 3D visualization 100 may be presented at a user interface to allow determining usage of components of a system. For example, the 3D visualization 100 may include solutions, such as an enterprise resource system, a customer relationship management system, and a sales relationship management system, and each of these solutions may include one or more functional areas comprising components relating to functions such as sales, marketing, electronic commerce, and the like. The system's solutions, areas, functions, and/or sub-functions may generally be considered components of that system.

In some implementations, 3D visualization 100 may be implemented as a page generated for presentation at the user interface, and this visualization may, in some implementations, be modeled as a city to provide a more intuitive and natural visualization of the usage of the system including components, although other representations may be used as well, such as a planetary system (for example, with districts, planets, moons, seas, and continents), molecules, and atoms, and other skeuomorphic representations. This 3D visualization 100 may thus enable a user to visualize and understand the usage of a given system including the software-based components therein.

In the example of FIG. 1, components 110A-C may represent certain types of functional components of a larger system, such as a business system. For example, components 110A-C may represent marketing 110A, sales 110B, and e-commerce components 110C (or areas) of a customer relationship management (CRM) system solution; components 112A-B may represent catalog 112B and electronic shopping service (ESS) 112A components (or areas) of a sales relationship management (SRM) system solution; and components 114A-B (or areas) may represent human capital management (HCM) 114A and sales 114B components of an enterprise resource planning (ERP) system solution, although other types and quantities of solutions and/or components may be used as well.

In the example of FIG. 1, components 110A-C, 112A-B, and 114A-B may be structured to represents buildings, which may be further organized into neighborhoods or districts of a city containing the buildings. For example, the 3D visualization 100 may divide a city 140 into one or more districts 142-146, each of which represents a specific type solution. For example, a district 142 represents a SRM district, a district 144 represents a CRM district, and a district 146 represents an ERP district.

In some example implementations, districts 142-144 may be sized based on a parameter, such as usage of corresponding district. For example, the more frequent and/or more often a solution is used, the larger the district. As such, an end-user's usage of the solutions may affect the size of a district, so a more frequently used district (or the corresponding solution therein) may be bigger from a less frequently used district (or the corresponding solution therein).

In some example implementations, the height of the building may also be varied based on a parameter, such as usage. In the example of FIG. 1, the e-commerce CRM component (or functional area of the CRM solution) 110C is depicted as having the greatest height, which in this example would indicate that the e-commerce CRM component (or functional area of the CRM solution) 110C is used more frequently (and/or for a longer duration) than other components 110A, B, 112A-B, and 114A-B.

In some example implementations, the building representative of a component/functional area may have connections. For example, connection 169A between ERP-HCM component/building 146 and SRM-ESS component/building 112A may represent that the two components are connected to each other. Moreover, the connections may be stack-oriented. For example, there may be a hierarchy of connections (for example, on different levels of a software stack). Moreover, the connections may be selectable on each level, so that a user can go up and down the stack and see the corresponding connections. These stack related dependencies may be visualized in the following way. Given a three stack software architecture, such as an application layer, a middleware layer, and a resource layer (for example, virtualization machines or physical hardware). The application layer may be represented by the city with its buildings (for example, CRM-Sales, SRM-ESS, and the like) and their connections. The interaction on this application layer may lead to an interaction on the middleware layer. In some implementations, an e-mail notification triggered at the application layer may be directed by a messaging system, such as a Java Messaging System, to the middleware layer (for example, send message to the e-mail system and then get relevant data from a database). This middleware interaction may be visualized by the representations disclosed herein as an item moving between layers via connections. In this example, the request to get data may lead to additional questions/queries on the third layer, the resource layer, such as what is impact of this database request to the CPU or the I/O system? Further, on the lowest layer, such as the virtualization layer, the impact to the central processing unit (CPU) and input/output (I/O) can be visualized in a dependency at the end of the application layer request in the beginning. As such, the stack-related interdependencies are visualized to make transparent the interdependencies between the layers, such as the three major layers noted above. The visualization may also be used to depict processing bottlenecks and other issues on a given layer, which can be triggered by an application-layer request.

In some example embodiments, the thickness (or some other graphically distinct indication) may be used to show a degree of dependency related to a connection. For example, a connection 169B is thicker than connection 169A, so connection 169B may represent greater traffic, which may correspond to substantial interaction between components 112B and 114A. In the example of FIG. 1, connection 169A includes two lines to show a two-way dependency, so component 112A connects on component 114A and component 114A connects on component 112A. However, a single line may be used at 169A to show a one-way connection. For example, a batch process may be considered a one-way connection, wherein all data will be transferred from a master data system to an operational system, while a two-way connection may correspond to a connection where data is transferred from one system to another and vice versa (for example, a login, sending user and password and receiving data in return).

In some example embodiments, a dashed line between buildings/components may also be used. For example, dashed line 169C between components 110B-C represent a virtual connection between two applications, wherein virtual refers to no direct connection between the two applications as there is only an indirect one via different applications and components.

In some example implementations, a selection at a user interface of a building at 100 may allow a user to drill down into the building to see more detail. For example, selecting component/building 110A a first time may provide a first level of parametric detail (for example, usage statistics and the like), while subsequent selections of component/building 110A may provide additional, different, and/or increasing levels of parametric information related to component/building 110A. Indeed, the drill down itself may be modeled as floors of component/building 110A. For example, drilling down into ERP sales building 114B may provide a first floor with sales lead management component information of the ERP system, such as usage of the sales lead management component information of the ERP system, and selecting component/building 114B again may present a second floor detail with usage for other components, such as the usage of the ERP Sales 114B e-mail notification component. Moreover, the size of a floor may indicate how often this part of the solution area is used, with a larger floor depicting greater usage. And, floors between buildings and/or in a specific building may be connected, as noted above, to show a dependency lead management and e-mail notification, such as get an e-mail notification from a lead. In some example implementations, a floor of a given building may be divided into rooms representative of additional sub-functional components. For example, the ERP sales building 114B may include a lead management component floor, which may allow a user to navigate through the visualization of the rooms to view sub-tasks/functions provided by the lead manager functional component, such as a “Creating Activity/Task for order confirmation” room or a “Task confirmation and creation of follow up document—Quotation” room.

In some example implementations, the usage of a solution or component therein may include determining the frequency of access of the solution/component, a duration of use of the solution/component, an average duration of the solution/component, and the like.

To get a clear understanding between the difference of usage of software and related code size, the following visualization may be provided. For example, at a user interface a selection may allow picking between usage and code size. If usage is selected, the usage of an application will be visualized, such as an SRM-ESS building having a first size representative of usage of the SRM-ESS software application. If code size is selected, the SRM-ESS building representation may change because the code size representation may dictate a larger or a smaller representation of the SRM-ESS building. In some implementations, both code size and usage can be presented in for example different colors, so in the previous example the SRM-ESS building may be sized in a first color to show usage and a sized in a second color to show code size. As such, the visualization may enable a user to see with a simple graphical view the usage and code size of one or more software applications or components therein. Table 1 depicts an example of components of a system and how the 3D visualization may model those to facilitate understanding by a user.

TABLE 1

| | | 3D Visualization/Model |
|---|---|---|
| # | Component | World |
| 1 | A system including a | City Map with n-districts |
| | plurality of solution types, | |
| | such as ERP, CRM, SRM, | |
| | and the like | |
| 2 | Usage of the types solutions | Vary size of the districts based |
| | | on relative usage of each of |
| | | the solution types |
| 3 | A certain solution | Represent as a certain district |
| 4 | Different functional areas in | Represent as buildings |
| | a certain solution | |
| 5 | Usage of functional/solution | Different size/height of the |
| | area | buildings |
| 6 | Scope of a solution area | Scope that is the different sub- |
| | | functional parts of a functional |
| | | area may be represented by |
| | | floors in a building |
| 7 | Duration of the usage | The average duration to stay in |
| | | a solution/area/etc may also |
| | | be indicated by a graphically |
| | | distinct element, such as |
| | | brightness, color, etc. |
| 8 | Call from one solution | The frequency of calls from |
| | (solution area) to another | one solution/area/etc to |
| | frequency | another may be visualized as |
| | | connections based on the of |
| | | packages which have to be |
| | | transported in a given time |
| | | frame |
| a | Synchrony | Single solid connection |
| | | directly from solution (area) to |
| | | the “other”-a data packages |
| | | transported with “light speed” |
| | | (maybe include real |
| | | performance figures and set |
| | | velocity accordingly) |
| b | Asynchrony | Solid connection with a shuttle |

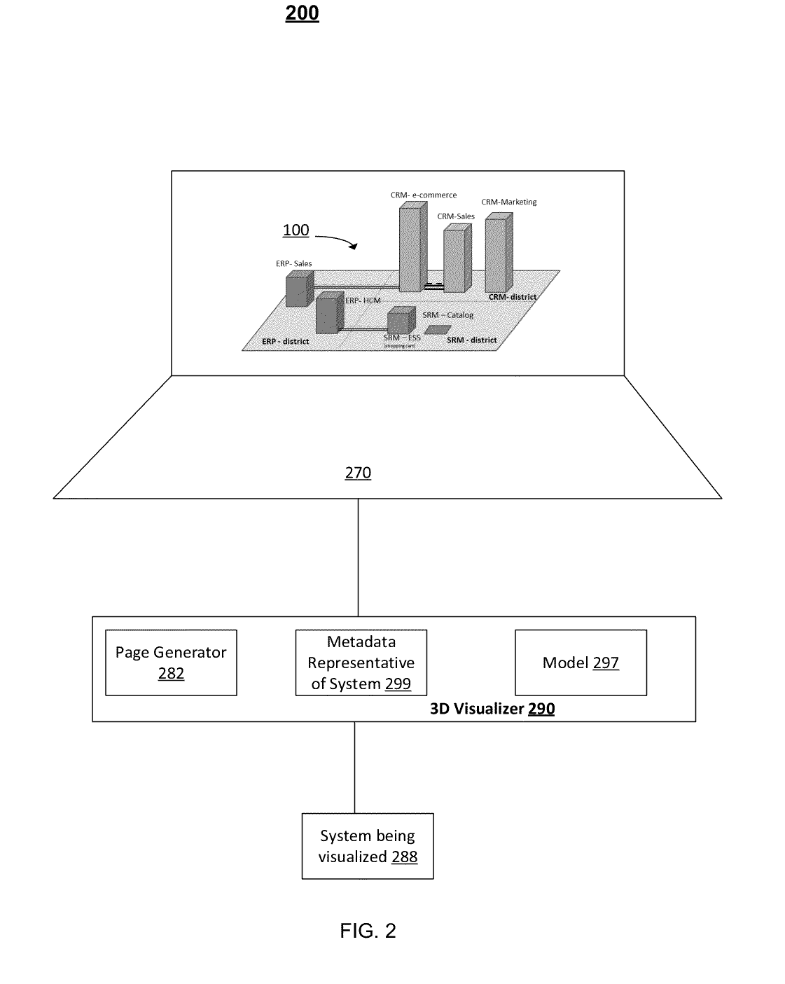

FIG. 2 depicts an example of a system 200 for generating a 3D visualization of software usage. The system 200 may include a computer 270 having a user interface where a page depicting a 3D visualization of software usage 100 can be presented. The page may be generated by a 3D visualizer 290 including a page generator 282.

3D visualizer 290 may accesses metadata representative of a system 288 being visualized, such as a system including, for example, a CRM solution, an ERP solution, and a SRM solution as noted above. This metadata may include the types of solutions being used at system 288, configuration information for those solutions, user access information related to system 288, how often users access those solutions including certain components/solutions/areas therein, inter-solution communications/accesses, and any other information representative of usage of system 288 including the solutions, components, and the like therein.

With the metadata, 3D visualizer 290 may then build a 3D visualization 100 based on a model 297, such as a model of a city including districts, buildings, roads, connections between buildings, and the like. For example, model 297 may take the form of definitions, such as those depicted at Table 1 above. Using the model, 3D visualizer 290 may then generate the 3D visualization 100 and provide that to page generator 282, which formats the 3D visualization 100 as a page for presentation at 270 (for example, in hypertext markup language and the like).

As a user selects a building or other element at 3D visualization 100, the 3D visualizer 290 may update the page with additional information, such as usage and other statistics/information, for the selected element. Moreover, in some example implementations, the 3D visualization 100 presented at 100 is presented as a so-called “walk-through” allowing the user at 270 to walk through the city to see the usage of system 100 in 3D.

Although the previous example described model 270 as a city including districts, other types of models may be used as well as noted above

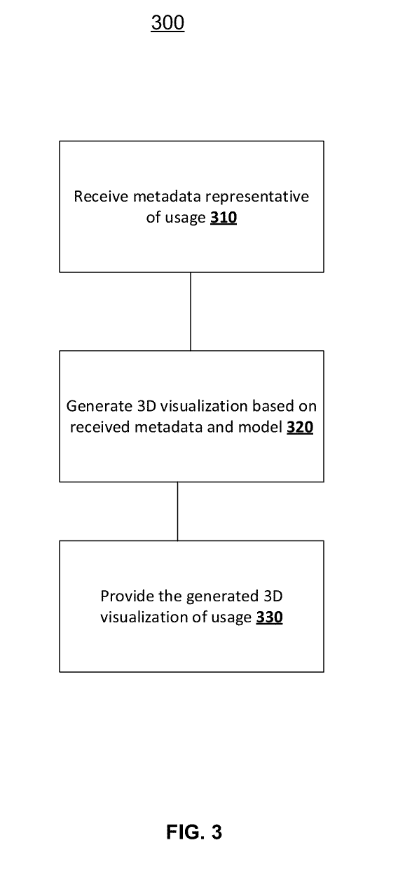

FIG. 3 depicts an example process 300 for generating a 3D visualization of software usage. The description of FIG. 3 also refers to FIGS. 1 and 2.

At 310, metadata 299 representative of usage of system 288 may be received. For example, the metadata 299 may be obtained by monitoring system 288 including solutions therein, such as CRM, ERP, SRM, and the like. Moreover, the monitoring may include determining user accesses, inter-solution communications such as calls and data exchanges, determining a landscape of system 288 including the types of solutions as well as the configuration of those solutions, and any other information representative of usage of system 288 including the solutions, components, and the like therein. Moreover, this metadata 299 may be stored in a repository access by 3D visualizer 288.

At 320, visualizer 290 may generate a 3D visualization based on the metadata 299 and a model 297. For example, visualizer may access the metadata for the solutions, such as CRM, ERP, SRM, and the like, and determine usage including parameters, such as duration of use of a solution or component therein, frequency of access, and the like. Based on the determined usage, visualizer 290 may then generate a city 140 including districts 142-146, size the districts, and configure buildings to represent components, such as 110A-C, 112A-B, and 114A-B, size the building based on usage, and then connect the buildings with connectors, such as connectors 169A-C. The visualizer 290 including page generator may then generate a page that can be presented at a user interface, such as a browser. At 330, the generated page representing the 3D visualization 100 may then be provided to computer 270 for presentation.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example, as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A computer-implemented method, comprising:
receiving metadata representative of usage of a component of a system;
generating, based on the received metadata and a model, a three-dimensional representation of the usage of the system including at least one of the component and a structure of the component, the model based on a geographic entity; and
providing the generated three-dimensional representation as a page for presentation.

2. The method of claim 1, wherein the geographic entity represents a city.

3. The method of claim 1, wherein the structure represents one or more layers of a software-based system including the component.

4. The method of claim 1, wherein the metadata comprises information representative of the system including the component, a configuration of the system including the component, a frequency of access to the component, and a code size for the component.

5. The method of claim 1, wherein the metadata further comprises other metadata for other components of the system, dependency information representative of a relationship among the component and the other components, and usage information for the component and the other components.

6. The method of claim 1, wherein the component is represented as a first building in the city generated on the page, and the other components are represented as other buildings in the city generated on the page.

7. The method of claim 6 further comprising:
receiving a first selection of the component representing the first building;
providing, in response to the selection, parametric information for the component, wherein the parametric is provided to the page for presentation at a user interface.

8. The method of claim 1 further comprising:
monitoring the system to obtain the metadata.

9. The method of claim 1, wherein the page presented at a user interface.

10. The method of claim 1, wherein the model defines the three-dimensional representation of the city including the component configured as a first building in the city generated on the page, other components represented as other buildings in the city generated on the page, a size for at least one of the first building and the other building based on at least the usage and a code size for the component or the other components.

11. A non-transitory computer readable medium including code which when executed by at least one processor provides operations comprising:
receiving metadata representative of usage of a component of a system;
generating, based on the received metadata and a model, a three-dimensional representation of the usage of the system including at least one of the component and a structure of the component, the model based on a geographic entity; and
providing the generated three-dimensional representation as a page for presentation.

12. The non-transitory computer readable medium of claim 11, wherein the geographic entity represents a city.

13. The non-transitory computer readable medium of claim 11, wherein the structure represents one or more layers of a software-based system including the component.

14. The non-transitory computer readable medium of claim 11, wherein the metadata comprises information representative of the system including the component, a configuration of the system including the component, a frequency of access to the component, and a code size for the component.

15. The non-transitory computer readable medium of claim 11, wherein the metadata further comprises other metadata for other components of the system, dependency information representative of a relationship among the component and the other components, and usage information for the component and the other components.

16. The non-transitory computer readable medium of claim 11, wherein the component is represented as a first building in the city generated on the page, and the other components are represented as other buildings in the city generated on the page.

17. The non-transitory computer readable medium of claim 16 further comprising:
receiving a first selection of the component representing the first building;
providing, in response to the selection, parametric information for the component, wherein the parametric is provided to the page for presentation at a user interface.

18. The non-transitory computer readable medium of claim 11 further comprising:
monitoring the system to obtain the metadata.

19. The non-transitory computer readable medium of claim 11, wherein the page presented at a user interface.

20. A system comprising:
at least one processor; and
at least one memory including code, which when executed by the at least one processor provides operations comprising:
receiving metadata representative of usage of a component of a system;
generating, based on the received metadata and a model, a three-dimensional representation of the usage of the system including at least one of the component and a structure of the component, the model based on a geographic entity; and
providing the generated three-dimensional representation as a page for presentation.
